(19) United States
(12) Patent Application Publication
(10) Pub. No.: US 2010/0169181 A1
(43) Pub. Date: Jul. 1, 2010

(54) METHOD OF NETWORKING REAL ESTATE AGENTS AND ADVERTISERS

(76) Inventor: Christopher J. Barbauld, Hobart, IN (US)

Correspondence Address: OVERHAUSER & LINDMAN, 740 W. GREEN MEADOWS DRIVE, SUITE 300, GREENFIELD, IN, 46140, US

(21) Appl. No.: 12/650,027

(22) Filed: Dec. 30, 2009

Related U.S. Application Data
(60) Provisional application No. 61/203,958, filed on Dec. 31, 2008.

(51) Int. Cl. G06Q 30/00; G06Q 10/00; G06Q 99/00; G06Q 50/00; H04N 1/60; G06F 17/30

(52) U.S. Cl. 705/14.61; 705/14.7; 705/14.72; 705/319; 358/1.9; 707/802; 707/E17.044

(57) ABSTRACT

A method of networking real estate agents and advertisers of products and services of interest to home buyers, with an illustrative embodiment including the steps of an independent intermediary identifying, possibly by computerized social networking, real estate agents willing to utilize promotional paper for hard-copies of real estate listings; contracts obligate the real estate agents to use or permit placement of the promotional paper; the intermediary identifies advertisers and executes contracts with them; the promotional paper is printed with a layout of advertisements and real estate listing data on opposing sides; the promotional paper is given to the real estate agents or placed by the intermediary; and the promotional paper is distributed to consumers. The method can be highly automated and executed with computers or other processors. Although one embodiment is configured for the residential real estate trade channel, others may relate to commercial real estate.

### CROSS-REFERENCE TO RELATED APPLICATION

This application claims the benefit of U.S. Provisional Patent Application No. 61/203,958, filed Dec. 31, 2008, and titled MLS BACKPAGE ADVERTISING, which is fully incorporated herein by reference.

### FIELD OF THE INVENTION

The present disclosure relates to paper for hard-copy real estate listings and, more particularly, to a method for integrating advertising with same.

### BACKGROUND

Even in this age of digitally-stored information, hard-copy real estate flyers remain an extremely popular means of distributing information about a house or other piece of real estate which is for sale.

The Real Estate Settlement Procedures Act (“RESPA”), codified at 12 U.S.C. §2601, et seq., admirably governs and sets ethical standards for the behavior of real estate agents and brokers. Among the many provisions of the RESPA law is the mandate that advertisers of products and services potentially of interest to home buyers are not to directly contract with real estate agents and brokers. The putative advertisers nevertheless have a great interest in reaching those people who are shopping for a new home, especially individuals who are new to a given geographic area and touring houses listed for sale. At the same time, the agents and brokers always have a need for the paper upon which their real estate flyers are printed.

### SUMMARY OF THE INVENTION

The present invention may comprise one or more of the following features and combinations thereof. An illustrative method including the steps of an independent intermediary initially identifying a real estate agent or broker, or an entire agency or brokerage office, willing to utilize a promotional paper having two sides, with advertising on one side, for hard-copies of real estate listings; a broker contract is executed, obligating those participating real estate agents and brokers to use the promotional paper whether the listings are placed outside a house, part of a compilation of listings, or otherwise generated and distributed; the intermediary identifies providers of products and/or services and executes advertising contracts with them; a graphic designer, the intermediary, or another party executes design software on a programmed computer or processor and prepares a multi-color layout of advertisements specified by the advertising contracts; a batch of the promotional paper is printed with the multi-color layout of advertisements outputted from a programmed computer or processor and displayed on only one side of the promotional paper, with the other side kept blank; the promotional paper may be given to the real estate agents and brokers which are parties to the broker contract; listings for certain real estate, possibly including house specifications, are added to the blank sides of the promotional paper by outputting information from a programmed computer or processor; and the promotional paper is distributed to real estate shoppers by means known in the art, including, but not limited to, flyer boxes and open houses.

The intermediary may serve as the party which adds the real estate listings to the promotional paper by outputting information from a programmed computer or processor and distributing the paper to real estate shoppers, by means such as flyer boxes placed at the sites of properties listed for sale by the participating real estate agents and brokers.

Advantageously, the method allows product manufacturers and service providers, in light of the RESPA statute, to ethically engage real estate agents and brokers and get their product and service advertising to reach consumers who are actively shopping the real estate market and likely have a current or future need for any number of products and services.

In one embodiment, computerized social networking and database techniques are employed to assemble data and identify potential participating real estate agents and brokers and possible advertisers. Further, the entire method of identifying participating agents and advertisers, building and populating a database to store agent and advertiser-related information, generating and executing the required contracts, creating advertising layouts, and printing the advertisements and the listing information can be performed by one or more specially-programmed computers or other processors.

Although an illustrative embodiment is configured for the residential real estate channel of trade, other embodiments may relate to commercial or unzoned real estate or properties which are available for renting, rather than purchase.

Additional features of the disclosure will become apparent to individuals skilled in the art upon consideration of the following detailed description of the illustrative embodiments.

### BRIEF DESCRIPTION OF THE DRAWINGS

The detailed description particularly refers to the accompanying figures in which:

FIG. 1 is a block diagram representing the steps of a first illustrative embodiment of a method of networking real estate agents and advertisers.

FIG. 2 is a diagram of an illustrative embodiment of a system which may be used to practice the claimed method of networking real estate agents and advertisers.

FIG. 3 is a block diagram representing the steps of a second illustrative embodiment of a method of networking real estate agents and advertisers.

### DETAILED DESCRIPTION OF THE ILLUSTRATIVE EMBODIMENTS

For the purposes of promoting and understanding the principles of the invention, reference will now be made to one or more embodiments illustrated in the drawings and specific language will be used to describe the same.

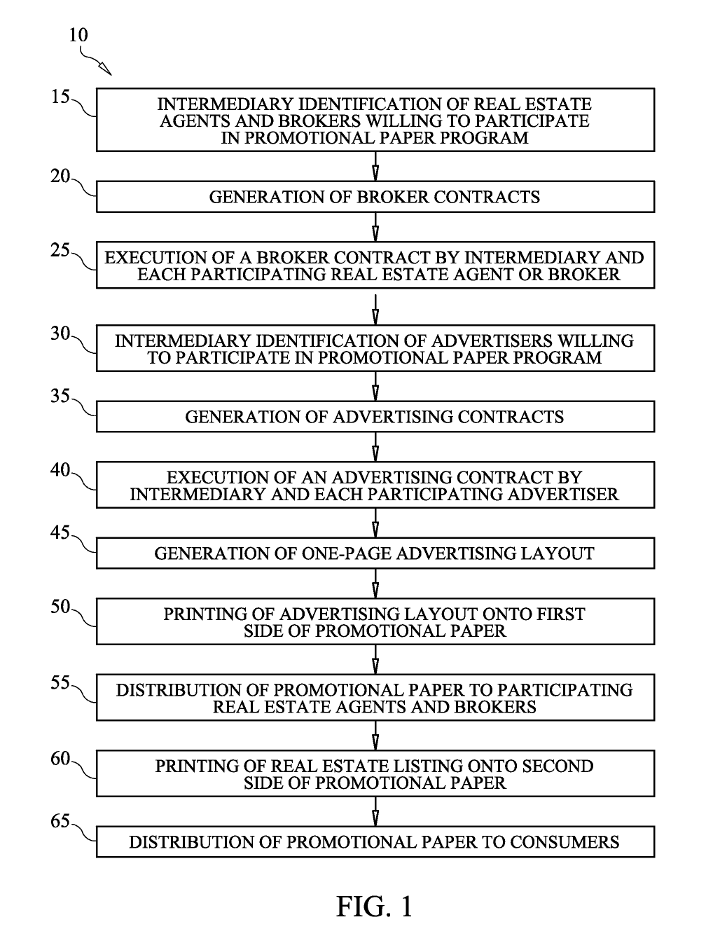

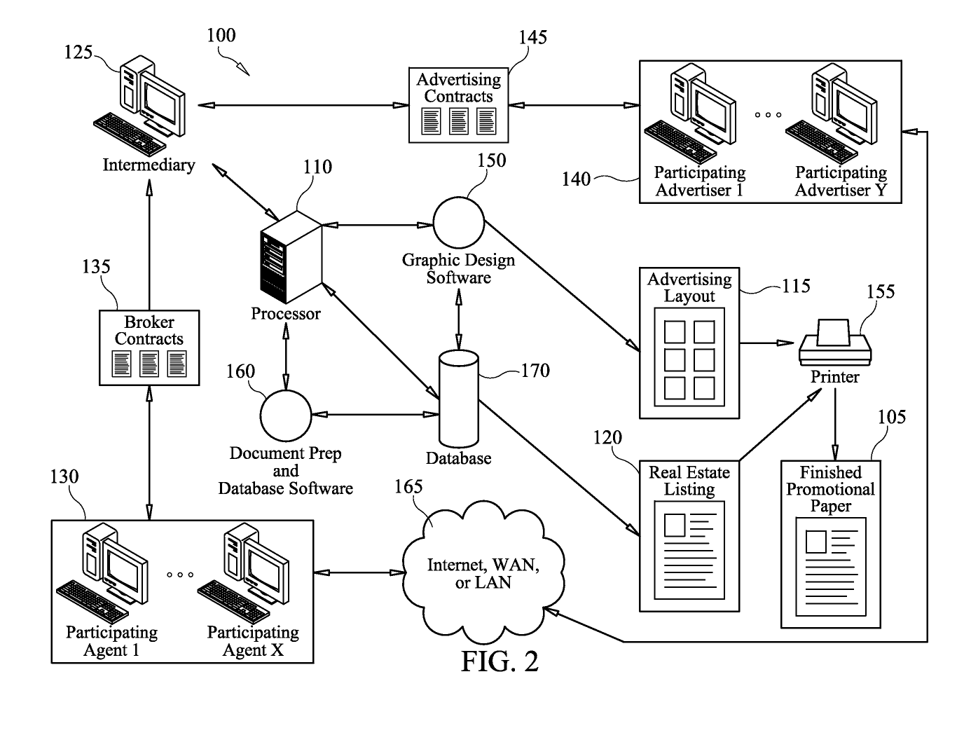

The RESPA statute, as part of its important objective of protecting real estate consumers, eliminates kickbacks and referral fees that unnecessarily increase the costs of certain settlement services. Accordingly, would-be advertisers are not allowed to directly engage real estate professionals, such as agents and brokers, with respect to advertising their products and services to clients of the agents and brokers and those shopping the real estate listed for sale by the agents and brokers. Referring to FIG. 1, a first illustrative embodiment of a RESPA-compliant method 10 for networking real estate agents and advertisers is shown. FIG. 2 depicts an illustrative embodiment of a system 100 which may be used to practice the claimed method 10.

In this embodiment, a promotional paper 105 necessarily has a first side physically transformed, by output from a programmed computer or processor 110, from a blank state to a side bearing advertising 115 and a second side similarly physically transformed, by output from a programmed computer or processor 110, from a blank state to a side bearing a real estate listing 120. More particularly, advertising 115, featuring advertising of products and/or services potentially of interest to consumers shopping the real estate market, is printed on one side of the promotional paper 105 while real property-related marketing data 120, including the categories of information utilized in connection with a Multiple Listing Service (MLS) real estate profile sheet, is printed onto the non-advertising side of the promotional paper 105.

As a first step 15, an independent intermediary 125, working as someone who is not in the employ of, or otherwise associated or affiliated with, any real estate professionals, finds at least one participating real estate agent or broker 130 willing to use the promotional paper 105. It is possible that more than one realty office may participate in a given agreement with the intermediary 125.

The participating real estate agents and brokers 130 may or may not be members of a MLS program, which is a suite of services that, among other things, is a device for the standardization and dissemination of property listing information to better serve the broker's clients, home-buying customers, and the public. An MLS database and related software can be used by real estate agents and brokers who represent sellers to widely share information about available properties with agents and brokers who represent potential buyers or who wish to cooperate with sellers' brokers in finding buyers for the properties.

A broker contract 135 is generated at step 20, and it is executed at step 25 by the intermediary 125 and one or more of the participating real estate agents and brokers 130. The broker contract 135 in the illustrative embodiment specifically grants the intermediary 125 the right to sell advertisements 115 on one side of the promotional paper 105 and obligates the participating real estate agents and brokers 130 to use the promotional paper 105, once output real property-related marketing data 120 has been printed thereon, whether the paper 105 is placed by an agent or broker 130, or the intermediary 125, on the site of an available property in a flyer box or part of a printout of multiple listings given to a consumer.

The broker contract 135 may include provisions standard in the print advertising industry, including, but not limited to, those concerning word and phrase definitions, promotional paper 105 size, advertising 115 color, term, termination, copyright and other intellectual property ownership, indemnification, and governing law, as well as provisions relating to promotional paper 105 lot size and the initial distribution to the participating real estate agent or broker 130. Another possible broker contract 135 provision is that the promotional paper 105 may not be used for any purpose other than disseminating hard-copies of real estate marketing information.

Pursuant to the terms of an illustrative broker contract 135, if a participating real estate agent or broker 130 does not use the promotional paper 105 or permit its on-site placement by the intermediary 125, the agent or broker 130 is to be considered in breach, legally liable therefor, and also responsible for indemnifying the intermediary 125 in the event one or more participating advertisers 140 initiate litigation over non-use of the paper 105. Similar provisions may specify that the participating agents and brokers 130 are not liable for copyright infringement with respect to anything appearing on the advertising 115 side of the promotional paper 105 and/or that the intermediary 125 is not liable with respect to anything appearing on the real estate listing 120 side of the promotional paper 105.

In this illustrative embodiment, if the broker contract 135 is executed on behalf of a real estate agency or brokerage office, all of the agents 130 working for that office, as employees or independent contractors, are obligated to use the promotional paper 105.

The broker contract 135, as an incentive in an illustrative embodiment, may specify that the intermediary 125 will be responsible for all costs incurred in the procurement, production, and printing of the advertisements 115 on the first side of the promotional paper 105 and/or the real estate listing 120 on the second side of the paper 105, essentially providing the promotional paper 105 free of charge to the participating agents and brokers 130.

In one embodiment, the broker contract 135 mandates that the participating real estate agents and brokers 130 provide the intermediary 125 with an estimate of the number of promotional papers 105 needed for a twelve-month period. The intermediary 125, pursuant to such a broker contract 135 term, may deliver three thousand sheets of promotional paper 105 to the participating agents and brokers 130 to use within six months, with the ability to replenish the paper 105 supply if a participating agent or broker 130 runs out before the six months are up.

The intermediary 125 also is responsible, at step 30, for identifying one or more participating advertisers 140, such as restaurants or stores within the general geographic area serviced by the participating real estate agents and brokers 130. Advertisers 140 which are geographically proximate to the property profiled on the promotional paper 105 are preferred, but if a given participating agent or broker 130 works over a large area, adjustments can be made by the intermediary 125. For example, in a remote geographic area with a limited market, multiple real estate agent 130 offices and all participating advertisers 140 in the area may partner on a promotional paper 105 deal arranged and executed by the intermediary 125.

Once advertisers 140 willing to participate in the promotional paper 105 program are found, advertising contracts 145 are generated by the intermediary 125 at step 35 and executed with the participating advertisers 140 at step 40. The advertising contracts 145 in an illustrative embodiment include, but are not limited to, standard print advertising provisions, such as word and phrase definitions; the agreement 145 term; cost allocation; reproduction, distribution, copyright and other intellectual property ownership, cancellation, and content rejection rights; indemnification; warranties; governing law; and advertising 115 specifications, including provisions such as file format and font which are specific to digital advertising. Some or all of the advertising 115 specifications, such as size, delivery deadlines, and rate, may be memorialized in a separate insertion order and incorporated into the advertising contracts 145 by reference.

The advertisement 115 size can vary. In an illustrative embodiment, a ⅛-page advertisement 115 is the minimum size, and the agreement 145 term is twelve months. Additionally, the advertisers 140 must provide all text, graphics, and other required materials by a specified closing date, and participating advertisers 140 are given a right of first refusal as to future advertising 115 space.

As noted, the broker contract 135 in one embodiment is valid for a promotional paper 105 lot size of three thousand pages or six months, whichever comes first. Subsequent promotional paper 105 batches may feature the same or different advertisers 140, depending on whether the participating advertisers 140 have exercised their right of first refusal and agreed to continue their participation in the promotional paper 105 program.

The next step, 45, calls for a graphic designer, the intermediary 125, or another party to prepare a layout of the advertising 115 specified by the executed advertising contracts 145. Multiple-color advertising 115 can be used, with a four-color layout 115 being economical and still pleasing to the eye of the consumer. Advertising 115 smaller than a ⅛-page section or which consists of a one-color layout 115 is feasible, but not preferred, while a layout 115 focusing on participating advertisers 140 within a given city, town, or other geographic area is an option. Graphic design software 150 executed on a programmed computer or other processor 110 may assist the designer. After this stage, a specialty color printing device 155, with high-volume production and high-resolution capabilities, is used at step 50 to output the layout 115 and print it onto the first side of the promotional paper 105.

Distribution of the promotional paper 105 bearing the advertising layout 115, to the participating real estate agents and brokers 130 is another step, 55, in the illustrative embodiment. The real property-related marketing data 120 is outputted and printed, at step 60, onto the blank second side of the promotional paper 105 by the participating agents and brokers 130. This property marketing data 120 includes specification information utilized in connection with a MLS real estate profile sheet, such as the listing price, MLS number, property address, zoning status, the governmental book and page where the deed is recorded, lot size, construction materials, total square footage, the number of floors and rooms and the sizes of each, the applicable school district, appliance features, and the listing date and agent.

In the alternative, the intermediary 125 may use a specialty color printing device 155, with high-volume production and high-resolution capabilities, to output the real property-related marketing data 120 onto the second side of the promotional paper 105 prior to, or in lieu of, direct distribution to the participating agents and brokers 130. In such an embodiment, the intermediary 125 is the party which places the finished promotional paper 105 at the sites of various properties listed for sale by the participating agents and brokers 130.

At step 65, the promotional paper 105, bearing advertising 115 on one side and a real estate listing 120 on the other, is finally supplied to consumers, who are shopping for a new home, by methods such as flyer boxes, open houses, and distribution to individual clients or prospective buyers. Flyer box placement and installation may be arranged and performed by the intermediary 125.

Social networking, including so-called Web 2.0 computer-implemented technologies, is critical before and after the intermediary 125 makes deals and contracts with real estate brokers 130 and advertisers 140. To introduce agents and brokers 130 to current and potential advertisers 140, network them, and foster word-of-mouth business development, various options are available: online networking through a Web site controlled by the intermediary 125 or as a group on a third-party, business-oriented Web site such as Linkedln (which may be found via Web browser software at Uniform Resource Locator http://www.linkedin.com); parties hosted by the intermediary 125 or participating real estate agencies 130, including mixers geared toward potential advertisers 140; or jointly attending sporting events. The social networking likely results in one or more advertisers 140 desiring to partner, albeit through the intermediary 125, with a particular real estate agent, broker, or agency 130. As long as the claimed method 10 employing the independent intermediary 125 is used, an advertiser 140 may select any particular participating real estate agent or broker 130 on whose promotional paper 105 its advertisements 115 will appear.

As indicated, it is conceived that the social networking of real estate agents 130 and advertisers 140 may be accomplished at least in part online, through the use of computers or other processors 110 specially equipped, with Web browser software and a graphical user interface, to access the Internet or another wide-area or local electronic network 165 capable of communicating with a Web page or collection of individual Web pages forming a Web site, by virtue of a signal running through at least one server computer or processor. The signal can be transported through the Hypertext Transfer Protocol (HTTP), which may employ encryption to provide security and privacy for the networking parties.

Such a Web page or Web site is created and populated with content by methods known to those skilled in the computer science art, including, but not limited to, the formatting instructions of Hypertext Markup Language (HTML) or Extensible Hypertext Markup Language (XHTML).

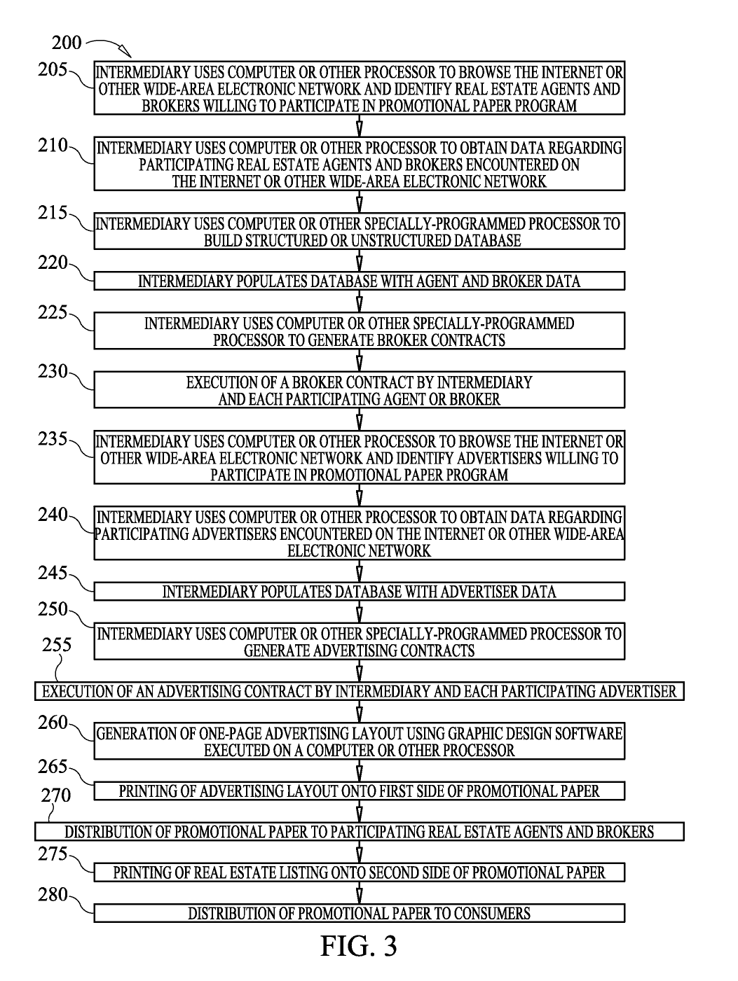

As illustrated in FIG. 3, the method disclosed herein could be implemented as a highly-automated process 200, with all of the parties “virtually” meeting at steps 205 and 235 and networking online, through a Web site or another wide-area or local electronic network 165, rather than in person; at steps 210 through 230 and steps 240 through 255, all of the required documentation and contracts being created, revised, updated, and stored on a computer or other processor 110, programmed with database and document preparation software 160 and controlled by the intermediary 125, and outputted and delivered online through the Internet or another wide-area electronic network 165; the advertising layout 115 being generated at step 260 with graphic design software 150 and similarly outputted and delivered online; and the printing, at steps 265 and 275, onto both sides of the promotional paper 105 being performed through one or more computers or other processors 110 specially programmed to control one or more high-volume printing devices 155.

The role of the computers or other processors 110 is inclusive and may be filled by machines such as desktop, notebook, or laptop computers; handheld portable devices; mobile telephones; or other client processors capable of communication over the Internet, a wide-area electronic network, a local-area electronic network, or another communication system 165.

A database 170 can be built at step 215 of this illustrative embodiment and used at steps 220 and 245 for storing and accessing contact information, notes, and other valuable data regarding real estate agents and brokers 130 and advertisers 140. More particularly, those skilled in the computer science art will see the benefits of using a structured database as a repository, wherein records and files are organized in a uniform format. A structured database processes data objects as ordered “relational” records with attribute pairing. For example, in contrast to a newspaper's unstructured database of individual articles, an online book retailer may use a structured database capable of returning, in response to a query, the title, format, and price of a particular work.

Optionally, the promotional paper 105 used in connection with the claimed method 10 may be heavy-stock (such as at least 24 lb.), glossy, matte, semi-gloss or satin-finish, or even water resistant. Glossy paper is shiny and has a more vibrant color quality that makes photographs printed thereupon appealing; it also has a tighter surface and is not as porous as other types of paper. Matte paper has no shine, but photographs printed thereupon are easier to view in a bright light environment, and it is generally less expensive than other types of paper.

In one illustrative embodiment, after first securing participating agents, brokers, or an entire office thereof 130, the intermediary 125 then finds one or more participating advertisers 140, the total number depending on the size of the advertising 115 space desired by the advertisers 140, to appear on the promotional paper 105. This sequencing of steps avoids the situation of the intermediary 125 making promises to advertisers 140 which cannot be kept. It should be understood, however, that all of the illustrated steps are merely exemplary. Other steps may be added, some may be omitted, and some or all may be performed with the aid of computers or other specially-programmed processors 110. Furthermore, variations in the step sequence are envisioned, and the order of the steps may certainly be changed for differing types of real estate.

While the invention has been illustrated and described in detail in the foregoing drawings and description, the same is to be considered as illustrative and not restrictive in character, it being understood that only illustrative embodiments thereof have been shown and described and that all changes and modifications which are within the scope of the claimed subject matter are desired to be protected.

1. A method of networking real estate agents and advertisers comprising the steps of:
an independent intermediary using a computer or other processor to obtain data regarding real estate agents and brokers willing to use a promotional paper in connection with real estate listings;
the independent intermediary building at least one database for storing and accessing information;
the independent intermediary populating the database with the data regarding real estate agents and brokers;
through the use of a computer or other processor programmed to access the database and provide document preparation services, the independent intermediary generating and executing a broker contract with each participating real estate agent and broker, thereby obligating all of the participating real estate agents and brokers to utilize the promotional paper or permit placement of the promotional paper;
the independent intermediary using a computer or other processor to obtain data regarding one or more participating advertisers;
the independent intermediary populating the database with the data regarding the participating advertisers;
through the use of a computer or other processor programmed to access the database and provide document preparation services, the independent intermediary generating and executing an advertising contract with each of the participating advertisers, memorializing specifics for advertising;
using a computer or other processor programmed to provide graphic design capabilities to prepare a one-page layout of all of the advertising specified in the advertising contracts;
printing upon the promotional paper, which has a first side and a second side, with both sides initially blank, thereby transforming the first side of the promotional paper from a blank state to a side bearing the one-page layout of advertising specified in the advertising contracts and transforming the second side of the promotional paper from a blank state to a side bearing a real estate listing;
distributing the promotional paper in bulk to the participating real estate agents and brokers or placing the promotional paper according to the broker contracts; and
providing the promotional paper to actual or potential real estate consumers.

2. The method of claim 1 wherein the database is a structured database.

3. A method of networking real estate agents and advertisers comprising the steps of:
an independent intermediary identifies one or more participating real estate agents and brokers willing to use a promotional paper in connection with real estate listings;
the independent intermediary generates and executes a broker contract with each of the participating real estate agents and brokers, thereby obligating all of the participating real estate agents and brokers to utilize the promotional paper or permit placement of the promotional paper;
the independent intermediary identifies one or more participating advertisers;
the independent intermediary generates and executes an advertising contract with each of the participating advertisers, memorializing specifics for advertising;
preparation of a one-page layout of all of the advertising specified in the advertising contracts;
the promotional paper, having a first side and a second side, with both sides initially blank, is printed upon, transforming the first side of the promotional paper from a blank state to a side bearing the one-page layout of advertising specified in the advertising contracts and transforming each second side of the promotional paper from a blank state to a side bearing a real estate listing;
the promotional paper is distributed in bulk to the participating real estate agents and brokers or placed according to the broker contracts; and
the promotional paper is provided to actual or potential real estate consumers.

4. The method of claim 3 wherein the advertising layout and the real estate listing are output from a computer or other processor.

5. The method of claim 3 wherein social networking techniques, including Internet-based techniques, are employed to identify and network the participating real estate agents and brokers and the participating advertisers.

6. The method of claim 1 wherein the participating real estate agents and brokers are residential real estate agents.

7. The method of claim 1 wherein the participating real estate agents and brokers are commercial real estate agents.

8. The method of claim 1 wherein the participating real estate agents and brokers are not members of a Multiple Listing Service (MLS) program.

9. The method of claim 1 wherein the participating real estate agents and brokers are affiliated with more than one real estate agency or office.

10. The method of claim 1 wherein the broker contracts specify that the promotional paper is to be utilized by the participating real estate agents and brokers solely in connection with hard-copy real estate listings.

11. The method of claim 1 wherein the broker contracts specify that the participating real estate agents and brokers will be in breach thereof if the promotional paper is not used or placed according to contractual terms.

12. The method of claim 1 wherein the broker contracts specify that a certain number of promotional paper sheets are to be used or placed within a certain period of time.

13. The method of claim 1 wherein advertising contracts are executed with between one and eight participating advertisers.

14. The method of claim 1 wherein participating advertisers can elect to have their advertisements reproduced only on the promotional paper distributed to, or placed on behalf of, certain participating real estate agents and brokers.

15. The method of claim 3 wherein the one-page layout of advertising is generated through the use of a computer or other processor executing graphic design software.

16. The method of claim 1 wherein the advertising in the layout varies in size.

17. The method of claim 1 wherein the layout is printed in more than one color.

18. The method of claim 1 wherein the printing and transforming of each second side of the promotional paper from a blank state to a side bearing real estate listings is performed by the participating real estate agents and brokers.

19. The method of claim 1 wherein the promotional paper is placed at properties appearing in the real estate listings.

20. The method of claim 1 wherein the promotional paper is provided to the actual or potential real estate consumers by insertion in flyer boxes.

21. The method of claim 3 wherein the intermediary identifies the participating real estate agents, brokers, and advertisers through the use of a computer or other processor programmed to provide Internet browsing capabilities; the broker contracts and the advertising contracts are generated through the use of a computer or other processor programmed to provide document preparation services and delivered through the Internet or other electronic network; the one-page layout of advertising is generated through the use of a computer or other processor executing graphic design software; and the printing is controlled by one or more computers or other specially-programmed processors.
